(19) United States
(12) Patent Application Publication
(10) Pub. No.: US 2015/0225572 A1
(43) Pub. Date: Aug. 13, 2015

(54) HIGH PERFORMANCE ANTIMICROBIAL COATING

(71) Applicant: CORNING INCORPORATED, CORNING, NY (US)

(72) Inventors: Dayue Jiang, Painted Post, NY (US); Jianguo Wang, Horseheads, NY (US)

(21) Appl. No.: 14/618,352

(22) Filed: Feb. 10, 2015

Related U.S. Application Data
(60) Provisional application No. 61/939,317, filed on Feb. 13, 2014.

(51) Int. Cl. C09D 5/14

(52) U.S. Cl. CPC C09D 5/14

(57) ABSTRACT

Embodiments of various antimicrobial coatings that exhibit high antimicrobial performance are provided. In one or more embodiments, the antimicrobial coating includes a carrier and a plurality of copper particles dispersed in the carrier. The particles include a stable copper state of Cu¹⁺. The stable copper state may include Cu⁰, Cu²⁺ or a combination thereof In one or more embodiments, the plurality of copper particles includes a hydrophobic outer surface. The copper particles may include a copper core and a porous shell. The carrier of one or more embodiments may include an amphiphilic polymer. Methods for forming such antimicrobial coatings are also provided.

### CROSS-REFERENCE TO RELATED APPLICATIONS

This application claims the benefit of priority under 35 U.S.C. §119 of U.S. Provisional Application Ser. No. 61/939,317 filed on Feb. 13, 2014, the content of which is relied upon and incorporated herein by reference in its entirety.

### BACKGROUND

The disclosure relates to a high performance antimicrobial coating including a carrier and a plurality of particles comprising a stable copper state of Cu¹⁺ and, more particularly, to a high performance antimicrobial coating in which the plurality of particles include a hydrophobic outer surface and are dispersed in the carrier such that the coating exhibits at least a 3 or 5 log reduction in at least one of Staphylococcus aureus, Enterobacter aerogenes, Pseudomonas aeruginosa bacteria, Methicillin Resistant Staphylococcus aureus, and E. coli, under EPA Test Method for Efficacy of Copper Alloy as a Sanitizer testing conditions.

Copper is an effective antimicrobial material or agent and has been approved by the US Environmental Protection Agency (EPA). Various methods and processes of making Cu-based materials, particularly copper-based alloys, have been developed. The development of such copper-based antimicrobial materials and surfaces faces at least two key technical challenges: the resulting materials and surfaces often exhibit 1) low antimicrobial activity; and 2) non-broad activity such that the activity is limited to one or two microbes (e.g., the material or surface exhibits antimicrobial activity against bacteria but not viruses or vice versa).

Efforts to address these two issues include the development of copper glasses, copper ceramics and/or copper-containing coatings (which may be inorganic or organic based). One solution includes an antimicrobial composite material that includes a polymer and copper coating. The formation of such coatings include, among others, the following parts: 1) synthesis of the copper-particles to provide copper in the oxidation form of Cu⁰ and/or Cu¹⁻; 2) dispersing the particles in polymer matrices to achieve a coating that can be easily applied onto different substrates; and 3) providing such coating that exhibits sufficient antimicrobial activity, when applied onto different substrates.

One solution to providing copper-particles having copper in the oxidation form of Cu⁰ and/or Cu¹⁺ includes the formation of a porous silica shell around a copper core to provide Cu/SiO₂ core/shell particles, as described in PCT Patent Application No. PCT/US2012/054126, entitled “Antimicrobial Composite Material”, the content of which is incorporated herein in its entirety. As will be described herein, such particles provide superior controlled release of the active copper species and improved anti-oxidation property, and thus, maintain high and long term antimicrobial performance.

Although such particles provide enhanced performance, there is a need to ensure adequate diffusion or leaching of the active copper species to the surface of coating at a controlled rate. Simply dispersing copper-particles, including the Cu/SiO₂ core/shell particles, into a polymer matrix often results in a coating having low antimicrobial performance. This is especially pronounced where a hydrophobic polymer is utilized. It is believed that the copper-particles are buried in the polymer matrix because such particles, by nature, are not compatible with the polymer matrix and thus, have a tendency to migrate to or deposit at the bottom of the coating during the course of making and curing of the coating. The presence of the copper-particles at the bottom of the coating and not the surface of the coating makes the active copper species inaccessible to bacteria and viruses. Moreover, hydrophobic polymer matrices, e.g. the paints/coating formulations, often block the active copper species from leaching out or diffusing out of the coating surface to function. The embodiments described herein provide a high performance antimicrobial coating that addresses these needs.

### SUMMARY

A first aspect of this disclosure pertains to an antimicrobial coating including a carrier and a plurality of copper particles dispersed in the carrier. In one or more embodiments, the particles comprising a stable copper state of Cu¹⁻. In other embodiments, the stable copper state may also include Cu⁰, Cu²⁺ or a combination thereof. The stable copper state of one or more embodiments is maintained after exposure to a reducing environment and/or an oxidizing environment.

In one or more embodiments, the plurality of copper particles include each include a copper core and a porous shell that at least partially surrounds the copper core. The porous shell can include an inner surface in communication or contact with the copper core and an outer surface that may be rendered or formed hydrophobic. The porous shell may include silica. In some examples, the porous shell may have a thickness in the range from about 0.01 to about 100 nm. The plurality of particles may include a molar ratio of the copper core to the porous shell of about 1:1 or greater. The molar ratio may be in the range from about 1:1 to about 10:1 or may specifically be about 4:1.

The plurality of copper particles of one or more embodiments may have an average diameter in the range of from about 100 nm to about 10 microns. The copper core may include less than about 20 wt % of Cu²⁺.

In accordance with one or more embodiments, the antimicrobial coating may include a balancing agent. The balancing agent may be provided so it is in communication with at least a portion of the outer surface of the porous shell. In other embodiments, the balancing agent may be used to render the outer surface of the porous shell hydrophobic. In one or more alternative embodiments, the copper particles may be free of a porous shell and may include a hydrophobic outer surface due to the presence of the balancing agent in the coating.

The balancing agent used in one or more embodiments may include a hydrophilic head and a hydrophobic tail. The hydrophilic head may be in communication or contact with the copper particles (and more specifically the porous shell of the copper particles, where applicable). Examples of suitable balancing agents include anionic surfactants, carboxylic acid-based surfactants, hydrophilic polymers, and water-soluble polymers. The balancing agent may be present in an amount in the range from about 0.1 wt % to about 2 wt %. The antimicrobial coating may include at least about 1 wt % of the plurality of copper particles. In some cases, the amount of the plurality of copper particles may be in the range from about 1 wt % to about 20 wt %.

The antimicrobial coating of one or more embodiments includes a polymer carrier. The carrier may include a pigment. Examples of suitable polymers include amphiphilic polymers, hydrophobic polymers, hydrophilic polymers or combinations thereof.

The antimicrobial coatings described herein may exhibit, after applied to a surface of a substrate, at least a 3 log reduction or even at least a 5 log reduction in the concentration of at least one of Staphylococcus aureus, Enterobacter aerogenes, Pseudomonas aeruginosa bacteria, Methicillin Resistant Staphylococcus aureus, and E. coli, under EPA Test Method for Efficacy of Copper Alloy as a Sanitizer testing conditions.

In some embodiments, the antimicrobial coating, after being applied to a surface of a substrate, exhibits a delta E of less than about 2, as measured by ASTM D2247, after being exposed to a temperature of 38° C. at 100% relative humidity for 7 days. In other embodiments, the antimicrobial coating, after being applied to a surface of a substrate, exhibits an adhesion of about 400 psi or greater, as measured by ASTM D4541.

A second aspect of the present invention pertains to a method of forming an antimicrobial coating. In one or more embodiments, the method includes synthesizing a plurality of copper particles having a stable copper state of and dispersing the plurality of copper particles in a carrier. In one or more embodiments, synthesizing a plurality of copper particles can include forming a copper core and at least partially surrounding the copper core with a porous shell, as described herein. In some embodiments, the method includes rendering at least a portion of the plurality of copper particles hydrophobic, which can include combining the plurality of particles with a balancing agent, as described herein.

Additional features and advantages will be set forth in the detailed description which follows, and in part will be readily apparent to those skilled in the art from that description or recognized by practicing the embodiments as described in the detailed description, the claims, and appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an illustration of a copper particle according to one or more embodiments.

FIG. 2A is an Electron Dispersive X-ray Spectrum (EDS) map/hyper-map of Si in copper particles, according to one or more embodiments.

FIG. 2B is an EDS map/hyper-map of Cu in copper particles, according to one or more embodiments.

FIG. 2C is an EDS map/hyper-map of Si and Cu in copper particles, according to one or more embodiments, with an inset image of a Scanning Electron Microscopy (SEM) image of such particles.

FIG. 3 is a liquid chromatography-mass spectrum (LC-MS) for sodium oleate.

FIG. 4 is an illustration of a copper particle and a balancing agent according to one or more embodiments.

FIG. 5 is a schematic illustration of the surface reconstruction ability of a comparative hydrophobic coating and a coating including an amphiphilic carrier, according to one or more embodiments.

FIG. 6 is a schematic illustration of the microstructure of an amphiphilic polymer.

FIG. 7 is a graph illustrating the relationship of contact angle with time for a coating with an amphiphilic polymer carrier, according to one or more embodiments.

FIG. 8 is a schematic illustration of function of a balancing agent, according to one or more embodiments.

FIG. 9 is an SEM image of the surface of a coating including copper particles and 1.0 wt % balancing agent, according to one or more embodiments.

FIG. 10 is a graph illustrating the relationship of contact angle with time for a coating with a balancing agent, according to one or more embodiments.

FIG. 11 is a graph illustrating the effect of a balancing agent on the contact angle of a coating, according to one or more embodiments, before and after washing.

FIG. 12 illustrates the effect of a balancing agent on the leaching rate of Cu¹⁺ from a coating that includes a 20% copper particle loading with 0% balancing agent, and coatings with 5%, 10% and 20% copper particle leading with 0.5% balancing agent.

FIG. 13 is a graph illustrating the relationship between Cu¹⁺ concentration and antimicrobial activity.

FIG. 14 is a graph illustrating the antimicrobial performance of a coating according to one or more embodiments and comparative coatings.

FIG. 15 is a graph illustrating the antimicrobial performance of various coatings having different copper particle loadings, according to one or more embodiments, and a comparative copper metal substrate.

FIG. 16 is a graph illustrating the antimicrobial performance of various coatings including different balancing agent amounts, according to one or more embodiments, and a comparative coating, with no balancing agent.

FIG. 17 is a graph illustrating the antimicrobial performance of various coatings including 15% copper particle loading and 1.0 wt % balancing agent, but different carriers, according to one or more embodiments.

FIG. 18 is a graph illustrating the antimicrobial performance of a coating according to one or more embodiments, before and after an environmental exposure at 38° C./95% relative humidity, for 24 hours, and a comparative copper metal substrate.

FIG. 19 is a graph illustrating the relationship of log reduction in Staphylococcus aureus and different particle loadings, according to one or more embodiments.

FIG. 20 is a graph comparing the sag resistance, as measured by ASTM D4400, of a coating according to one or more embodiments, and a known commercially available paint.

### DETAILED DESCRIPTION

Reference will now be made in detail to various embodiment(s), some of which are illustrated in the accompanying drawings.

One aspect of this disclosure pertains to a high performance and durable antimicrobial coating that exhibits balanced hydrophilic-hydrophobic properties and improved copper particle dispersion. One or more embodiments of the coating include a carrier and copper-particles dispersed therein, wherein the particles include a stable copper state. In one or more embodiments, the stable copper state includes Cu¹⁺. The stable copper state may optionally also include Cu⁰ and/or Cu²⁺. As used herein, the phrase “stable copper state” includes a copper state (e.g., Cu⁰, Cu¹⁺ and/or Cu²⁻) that is maintained after exposure of the copper particles or the coating to a reducing environment, an oxidizing environment or other environment known to induce change(s) in the oxidation state of copper. In other words, where the copper particles include a stable copper state of Cu¹⁺ such state is maintained even when the copper particles or the coating in which the copper particles are incorporated are exposed to a reducing environment, an oxidizing environment or other environment that causes changes in the oxidation state of copper. Similarly, where the stable copper state includes Cu⁰ and/or Cu²⁺, such copper particles will maintain this stable copper state. As will be described herein, the stability of the particles, with respect to copper state, is achieved in various ways, such as the use of a porous shell to prevent undesirable oxidation or reduction or the use of an amphiphilic polymer carrier.

The coating of one or more embodiments also includes a balancing agent that balances the hydrophobic-hydrophilic properties of the coating and unifies the dispersion of the copper-particles in the carrier to lift the particles to the surface of the resulting coating. The carriers are not limited and can include a variety of polymers often found in coating formulations, dispersions, paints and surfactants.

The coatings described herein exhibit high antimicrobial activity by including a stable Cu¹⁺ copper state. In one or more embodiments, the coating also exhibits high antimicrobial activity by having balanced hydrophilic-hydrophobic properties. In known coatings, additional oxidation or reduction steps are required to provide copper in the Cu¹⁺ state. Moreover, other known coatings often do not exhibit balanced hydrophilic-hydrophobic properties and often require a surface treatment to expose or bring the copper-particles to the surface of the coating. The coatings described herein do not require such reduction/oxidizing treatment or surface treatment as the active copper species is in the Cu^{1|} copper state and readily diffuses or leaches out of interior portions of the coating to the surface thereof, where it exhibits high antimicrobial efficacy. As used herein, “active copper species” includes one or more of Cu¹⁺, Cu⁰ and Cu²⁺ ions.

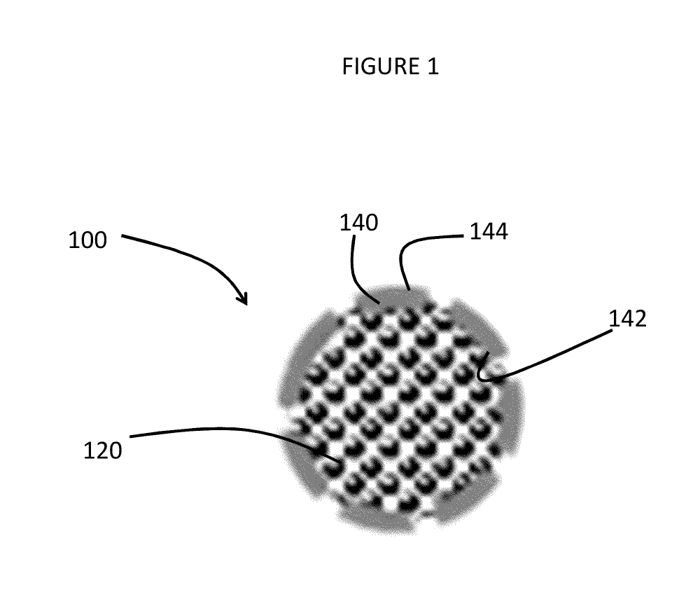

As shown in FIG. 1, the copper particles 100 may include a copper core 120 and a porous shell 140 that at least partially surrounds the copper core. The porous shell includes an inner surface 142 in communication with the copper core 120 and an outer surface 144. When the copper particles 100 are dispersed in the carrier, the outer surface 144 is in communication with the carrier.

In one or more embodiments, the copper core includes copper in the stable copper state of Cu¹⁺ and optionally, copper in the stable copper states of Cu⁰, Cu²⁺, or combinations thereof. The stable copper state of Cu¹⁺ may be present in the copper core as Cu₂O. Where applicable, Cu⁰ may be present in the copper core in the form of metallic copper and Cu²⁻ may be present in the copper core in the form of CuO. In one or more embodiments, the copper core includes copper having only the oxidation state of Cu¹⁺. In one or more specific embodiments, the copper core may include copper having an oxidation state of Cu¹⁺ in an amount of at least about 50 wt %, at least about 60 wt %, at least about 70 wt %, of the copper core. In one or more embodiments, the copper core may include less than about 20 wt %, less than about 10 wt %, less than about 5 wt %, or less than about 1 wt % copper having an oxidation state of Cu²⁺. In some alternative embodiments, the copper core may be substantially free of Cu²⁺. As used herein, the phrase “substantially free” includes an amount of about 0.1 wt % or less.

In some embodiments, the copper particles includes a porous shell surrounds substantially all of the surface area of the copper core (e.g., at least about 95% of the surface area of the copper core). In other embodiments, the porous shell surrounds at least about 20%, at least about 30%, at least about 40%, at least about 50%, at least about 60%, at least about 70%, at least about 80% or at least about 90% of the surface area of the copper core. In some specific embodiments, at least about 50% of the particles in the coating include a porous shell that surrounds substantially all of the surface area of the copper core or surrounds at least about 20% of the surface area of the copper core.

In one or more embodiments, the copper particles may include a porous shell formed from SiO₂. The thickness of the porous shell may be in the range from about 0.01 nm to about 100 nm. In some embodiments, the thickness range may be from about 0.01 nm to about 90 nm, from about 0.01 nm to about 80 nm, from about 0.01 nm to about 70 nm, from about 0.01 nm to about 60 nm, from about 0.01 nm to about 50 nm, from about 0.1 nm to about 100 nm, from about 1 nm to about 100 nm, from about 5 nm to about 100 nm, from about 10 nm to about 100 nm, from about 20 nm to about 100 nm, from about 30 nm to about 100 nm, from about 40 nm to about 100 nm, from about 50 nm to about 100 nm, and all ranges and sub-ranges therebetween.

The copper particles described herein may include a molar ratio (mol/mol) of copper core to porous shell of about 1:1 or greater. For example, the molar ratio may be in the range from about 1:1 to about 10:1, from about 1:1 to about 9:1, from about 1:1 to about 8:1, from about 1:1 to about 7:1, from about 1:1 to about 6:1, from about 1:1 to about 5:1, from about 1:1 to about 4:1, from about 2:1 to about 10:1, from about 3:1 to about 10:1, from about 4:1 to about 10:1, from about 3:1 to about 5:1, and all ranges and sub-ranges therebetween. In some specific examples, the molar ratio of copper core to porous shell may be about 4:1.

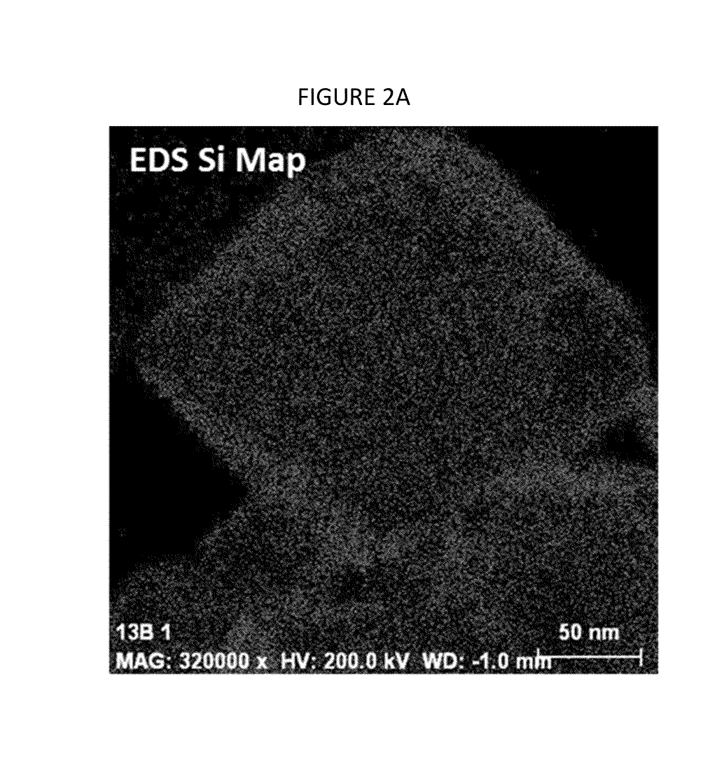

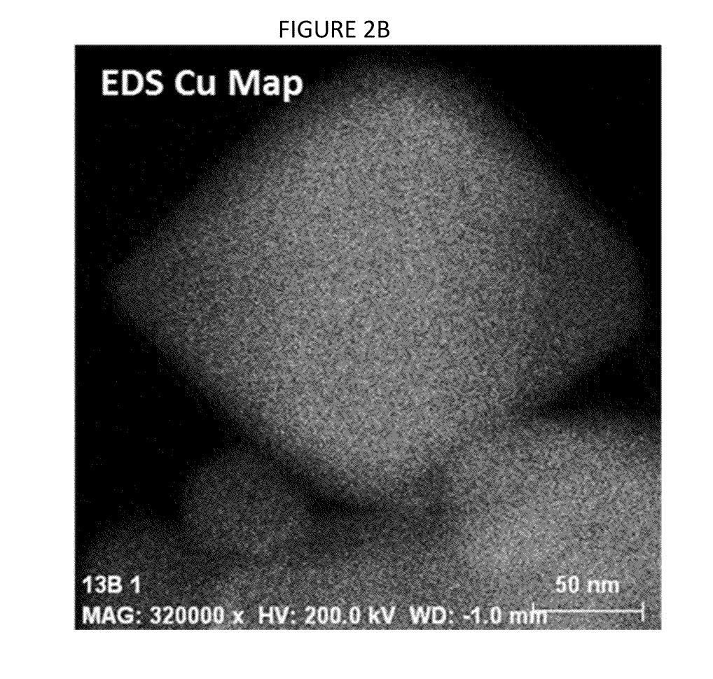

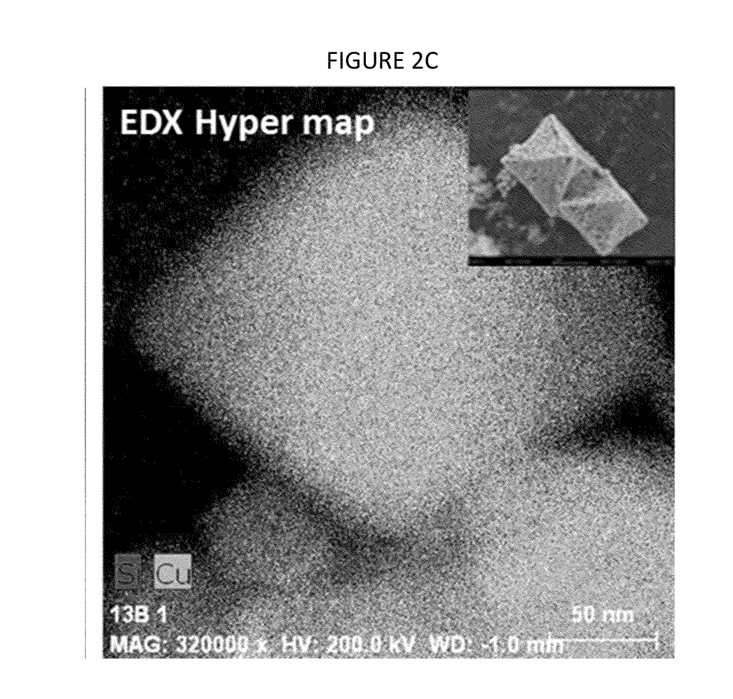

In one example, the copper particles described herein may include a copper core that includes Cu₂O and a porous SiO₂ shell having a molar ratio of about 4:1 (mol/mol). The porous SiO₂ shell may have a thickness in the range from about 5 nm to about 10 nm. FIGS. 2A, 2B and 2C show EDS map/hyper-maps of some exemplary copper particles. FIG. 2A shows the SiO₂ shell and FIG. 2B shows the copper core of such copper particles. FIG. 2C shows both the SiO₂ shell and the copper core and includes an inset SEM image of the same copper particles.

As mentioned herein, the core/shell structure of the copper particles of one or more embodiments demonstrated a significantly better anti-oxidation performance and controlled release of active copper species, as compared to the copper particles that do not include a shell (whether porous or non-porous). Without being bound by theory, it is believed that copper particles having copper in the oxidation state of Cu¹⁺ or Cu⁰ are sensitive to oxidation in oxygen and/or air (Cu+O₂→Cu₂O and Cu₂O+2H⁺→Cu+Cu²⁺+H₂O, a disproportion reaction). The shell used herein prevents the copper core from being oxidized or oxidized rapidly, while the porous structure of the shell permits the active copper species from the copper core to leach out to the coating surface and exhibit antimicrobial activity. Accordingly, the copper particles described herein exhibit significantly better stability, than copper particles that have the same or similar core but without a shell.

The copper particles of one or more embodiments may have an average diameter in the range from about 100 nm to about 20 μm. In some embodiments, the average diameter of the copper particles may be in the range from about 100 nm to about 9 μm, from about 100 nm to about 8 nm, from about 100 nm to about 7 μm, from about 100 nm to about 6 μm, from about 100 nm to about 5 μm, from about 100 nm to about 4.5 μm, from about 100 nm to about 4 μm, from about 100 nm to about 3.5 μm, from about 100 nm to about 3 μm, from about 100 nm to about 2 μm, from about 250 nm to about 5 μm, from about 500 nm to about 5 μm, from about 750 nm to about 5 μm, from about 1 μm to about 5 μm, from about 2 μm to about 5 μm, and all ranges and sub-ranges therebetween. In some instances, the copper particles have a particle size distribution D50 in the range from about 100 nm to about 20

In one or more embodiments, the outer surface of the copper particles is hydrophobic. The copper particles may exhibit such hydrophobicity when a porous shell is present or when no porous shell is present. In some embodiments, at least 50% or at least about 90% of the surface area of the outer surface of the copper particles exhibits hydrophobicity.

Before combination with a carrier and/or balancing agent, the plurality of particles may be provided in an alcohol suspension.

In one or more embodiments, the coating may include a balancing agent in communication with at least a portion of the outer surface of the copper particles. In some instances, the balancing agent forms a coating or covering on the outer surface of the copper particles, thus imparting hydrophobicity to the outer surface of the particles. The balancing agent may form a coating that at least partially covers the outer surface of the copper particles. In some instances, the balancing agent may cover at least about 10%, at least about 20%, at least about 30%, at least about 40%, at least about 50%, at least about 60%, at least about 70%, at least about 80% or at least about 90% of the surface area of the outer surface of the copper particles.

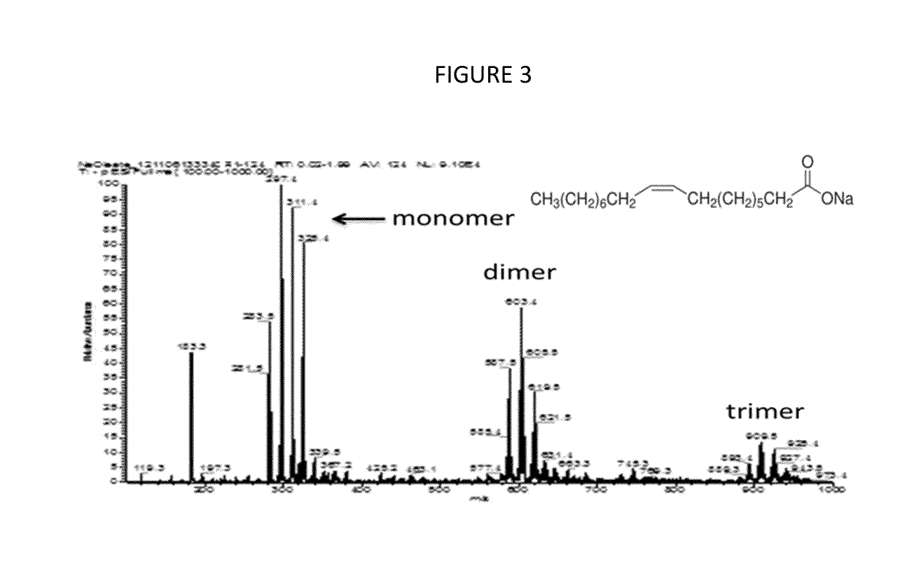

Suitable balancing agents may include a hydrophilic head and a hydrophobic tail. Non-limiting examples of such balancing agents include anionic surfactants, such as sulfonic acid based surfactants (e.g., sodium dodecyl sulfate (SDS) and sodium 4-dodecylbenzenesulfate (SDBS)), carboxylic acid-based surfactants, hydrophilic polymers, and water-soluble polymers. A specific example of a suitable anionic surfactant includes sodium oleate (SOA). As shown in the LC-MS shown in FIG. 3, SOA includes a structure existing in the form of monomer, dimer and trimer, etc. because of a double bond. SOA and other balancing agents are utilized in the coating described herein to balance the hydrophilic/hydrophobic properties of the coating and/or as a dispersing agent to disperse the particles in the carrier.

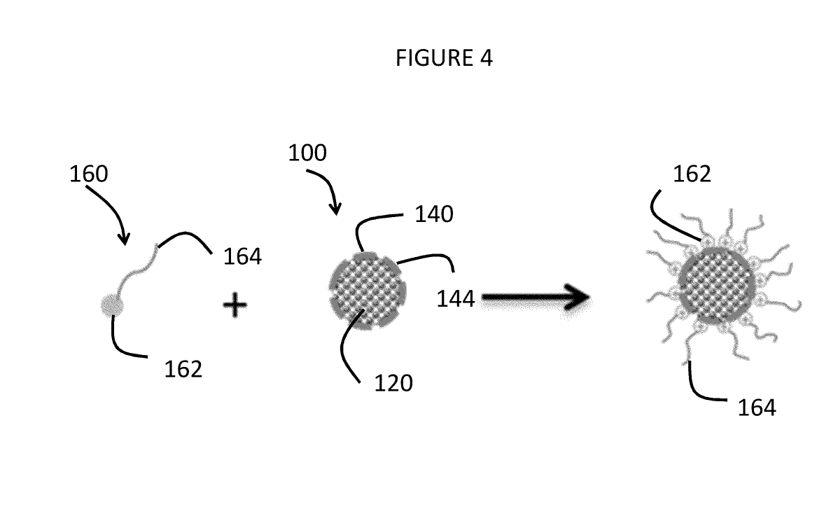

In one or more embodiments, the balancing agent is provided on the copper particles such that the hydrophilic head is in communication with the copper particles and the hydrophobic tail is oriented outwardly from the copper particle. In the embodiment shown in FIG. 4, the copper particles 100 include a copper core 120, a porous shell 140 and the balancing agent 160 at least partially surrounding the porous shell. The balancing agent 160 includes a hydrophilic head 162 in communication with the porous shell 140 and a hydrophobic tail 164 that radiates outwardly from the outer surface of the porous shell.

In one or more embodiments, the amount of the balancing agent in the coating may be in the range from about 0.01 wt % to about 5 wt % or, more specifically, from about 0.1 wt % to about 2 wt % of the coating. In some embodiments, the range can vary from about 0.01 wt % to about 4.5 wt %, from about 0.01 wt % to about 4 wt %, from about 0.01 wt % to about 3.5 wt %, from about 0.01 wt % to about 3 wt %, from about 0.01 wt % to about 3.5 wt %, from about 0.01 wt % to about 3 wt %, from about 0.1 wt % to about 5 wt %, from about 0.5 wt % to about 5 wt %, from about 1 wt % to about 5 wt %, from about 0.1 wt % to about 3 wt %, from about 0.1 wt % to about 2.5 wt %, and all ranges and sub-ranges therebetween.

The coating may include at least about 1 wt % of the plurality of copper particles. In some instances, the coating may include from about 1 wt % to about 20 wt % of the plurality of copper particles. The range may vary and may include from about 1 wt % to about 18 wt %, from about 1 wt % to about 16 wt %, from about 1 wt % to about 14 wt %, from about 1 wt % to about 12 wt %, from about 1 wt % to about 10 wt %, from about 2 wt % to about 20 wt %, from about 4 wt % to about 20 wt %, from about 6 wt % to about 20 wt %, from about 8 wt % to about 20 wt %, from about 10 wt % to about 20 wt % and all ranges and sub-ranges therebetween.

In one or more embodiments, the coating includes a carrier that may include either a polymer or a blend of oligomers with reactive monomers. In one or more embodiments, the carrier may be a polymerizable monomer. The polymer can include a pigment, thus providing a paint or other similar coating. In some embodiments, the polymer may be amphiphilic, hydrophobic, hydrophilic or a combination thereof. Examples of suitable polymers includes commercially available paint formulations, which may have finishes that range from flat to glossy, such as Polycrylic® clear gloss, Behr® white semi-gloss, Behr 0 white satin and Behr® beep base flat.

In some embodiments, the carrier included an amphiphilic polymer. Such polymers are believed to balance the hydrophobic-hydrophilic property of the coating and may be utilized alternatively or additionally to the balancing agent. In one or more embodiments, amphiphilic carriers may also be utilized to facilitate the copper state stability of the copper particles. In such embodiments, the amphiphilic polymer may be used alternatively or additional to porous shells.

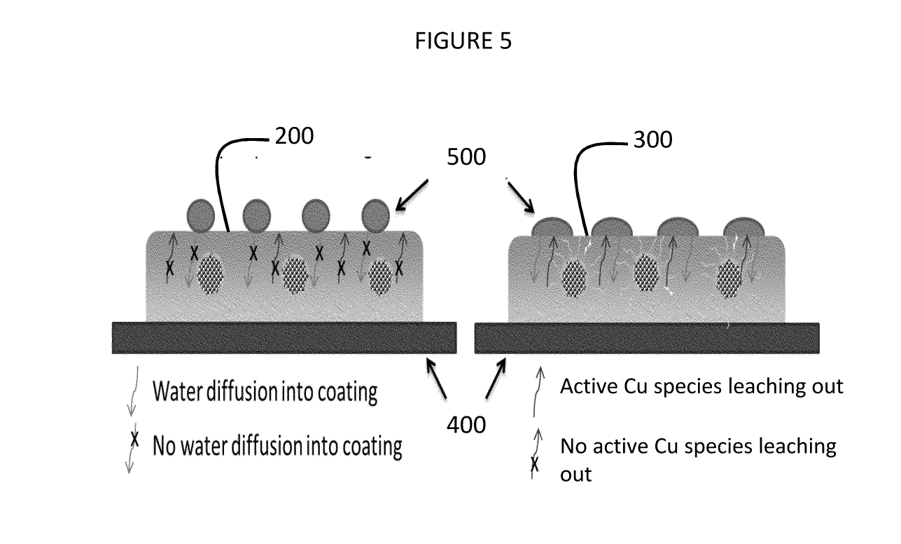

As mentioned herein, the active copper species must diffuse to the coating surface to provide antimicrobial activity. This diffusion is facilitated by balanced hydrophobic-hydrophilic properties in the coating. An amphiphilic polymer exhibits such balanced properties because it possesses an ability to absorb moisture/water, which can initiate a surface reconstruction of the coating and functions as the carrier of the active copper species in diffusing or leaching out onto the surface of the coating. This mechanism is shown in FIG. 5, which illustrates the ability of surface reconstruction of a hydrophobic coating 200 and a amphiphilic coating 300, which include the copper particles described herein. The hydrophobic coating 200 and the amphiphilic coating 300 are disposed on the same substrate 400. Water droplets 500 are shown on the surface of the hydrophobic coating 200 and the amphiphilic coating 300. As shown in FIG. 5, the hydrophobic coating 200 does not permit water diffusion into the coating and does not permit active copper species from leaching out. In contrast, the amphiphilic coating 300 permits water diffusion into the coating and active copper species leaching out.

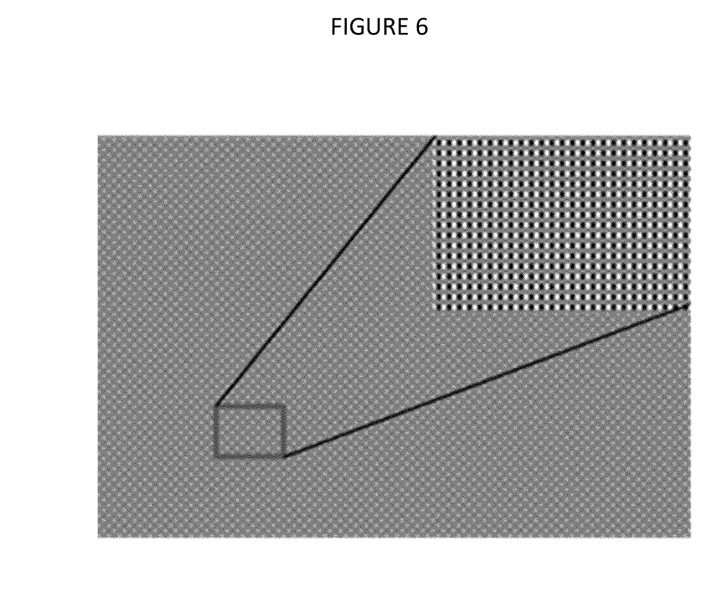

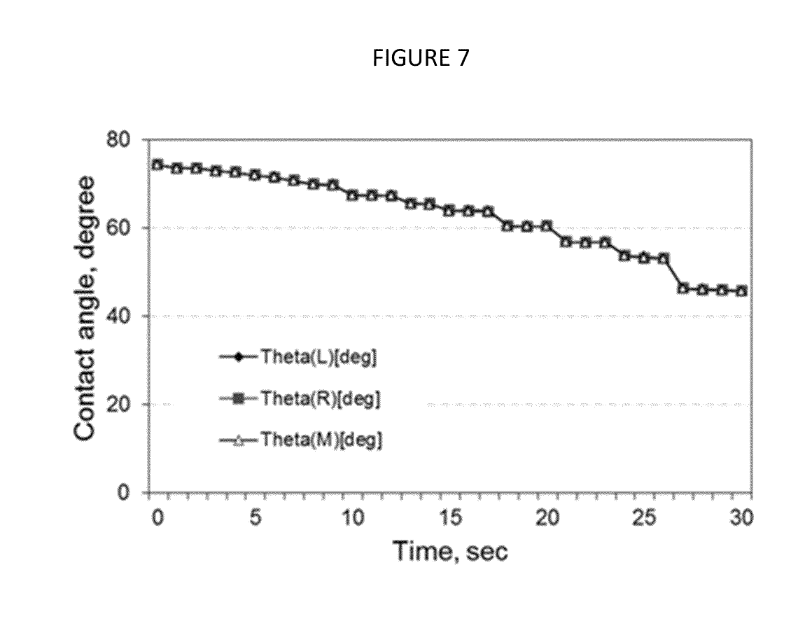

Micro-structurally, an amphiphilic polymer contains hydrophobic and hydrophilic moieties or components. After it is incorporated into the coatings described herein, the amphiphilic polymer forms two domains: a hydrophobic domain, and a hydrophilic domain, as shown in FIG. 6. The hydrophilic domain, particularly for an amphiphilic polymer having its T_{g} close to room temperature, has a capacity of water absorption and hence the coating shows an ability of surface reconstruction in the presence of moisture or water, e.g., dropping water onto its surface. This has been seen in the change of contact angle for the amphiphilic polymer-containing coating, as shown in FIG. 7.

When combined with the copper particles described herein, the surface reconstruction ability of the coatings described herein allow the copper particles, or more specifically, the active copper species, to leach or diffuse out from the interior portions of the coating to the surface when in a “wet condition” and to remain in the coating when in a “dry condition”. As used herein, the phrase “wet condition” can include the presence of a liquid (e.g., water, solvent or solutions) on the surface of the coating. In some instances, a “wet condition” may be present where the environment has a humidity in the range from about 38% to about 42% or greater, at a temperature of about 23° C. to about 37° C. As used herein, the phrase “dry condition” includes the absence of a liquid (e.g., water, solvent or solutions) on the surface of the coating. In some instances, a “dry condition” may be present where environment has a humidity of less than about 38%, at a temperature of about 23° C. to about 37° C. As amphiphilic polymers include both hydrophobic and hydrophilic moieties, such polymers can exhibit an “on and off” property depending on whether the polymer is in a wet condition or a dry condition. In a dry condition, which is driven by the polymer-air interface interaction, the hydrophobic moiety of the amphiphilic polymer (which has a low surface energy) enriches and seals the coating surface. This provides a type of protection to the particles in the coating by preventing direct exposure to air/moisture (i.e., this forms the “off stage”). On the other hand, in a wet condition, the hydrophilic moiety of the amphiphilic polymer absorbs the moisture, which leads to the hydrophilic moiety being increasingly exposed at the surface and thus absorbing more water. The absorption of water facilitates diffusion or leaching of the active copper species from within the coating to the surface and hence provide antimicrobial activity by killing both the viruses and the bacteria (i.e., this forms the “on stage”).

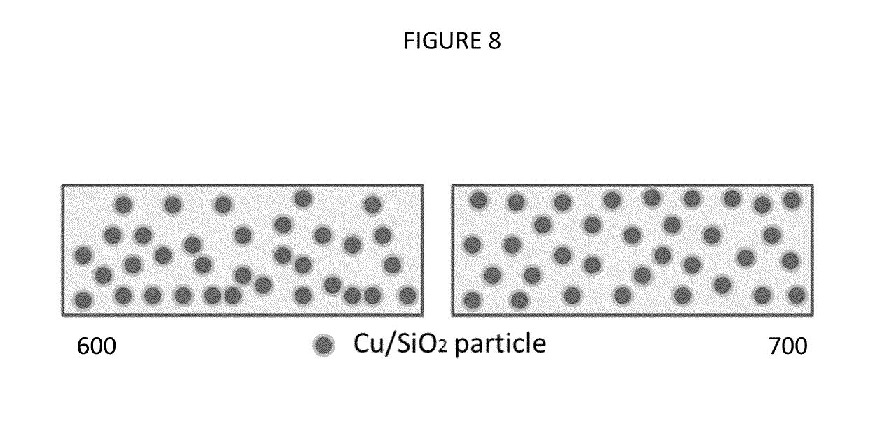

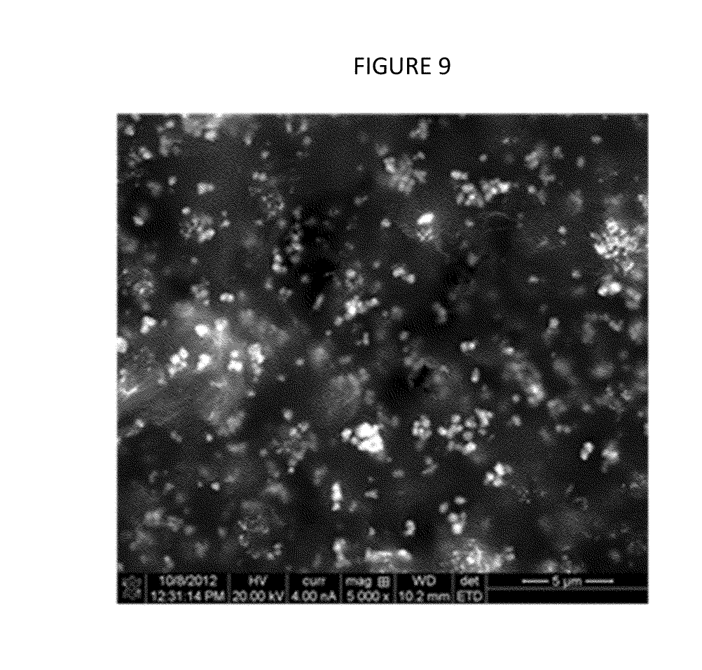

The property of the surface reconstruction of an amphiphilic polymer has showed a benefit to the coatings described herein; however in some instances, where even greater antimicrobial performance is desired, simply dispersing the copper particles described herein into an amphiphilic polymer did not necessarily result in such antimicrobial performance In such cases, the particles were found to not be sufficiently dispersed in the carrier. Accordingly, the use of a balancing agent may be useful to improve copper particle dispersion in the carrier. The balancing agent, when at least partially in communication with the copper particles enables better dispersion of the particles. Moreover, the particles were found to be present at the surface of the coating, when a balancing agent is utilized. FIG. 8 shows a schematic illustration of the function of the balancing agent on the dispersion of the copper particles in a coating. In FIG. 8, 600 indicates a coating without the balancing agent and 700 indicates a coating with the balancing agent. As shown in FIG. 8, the copper particles are better dispersed in the coating with a balancing agent 700. FIG. 9 shows an SEM image of the surface of an exemplary coating including a Polycrylic® carrier, 1.0 wt % balancing agent (i.e., SOA) and a plurality of copper particles. The SEM image shows the makeup of the top surface of the coating (i.e., the first few nanometers of the coating) and, thus, shows the amount of copper particles at the surface. FIG. 9 shows the presence of copper particles on or at the surface of the coating. More specifically, the white portions of the SEM image represent copper particles, and the dark portions represent the carrier.

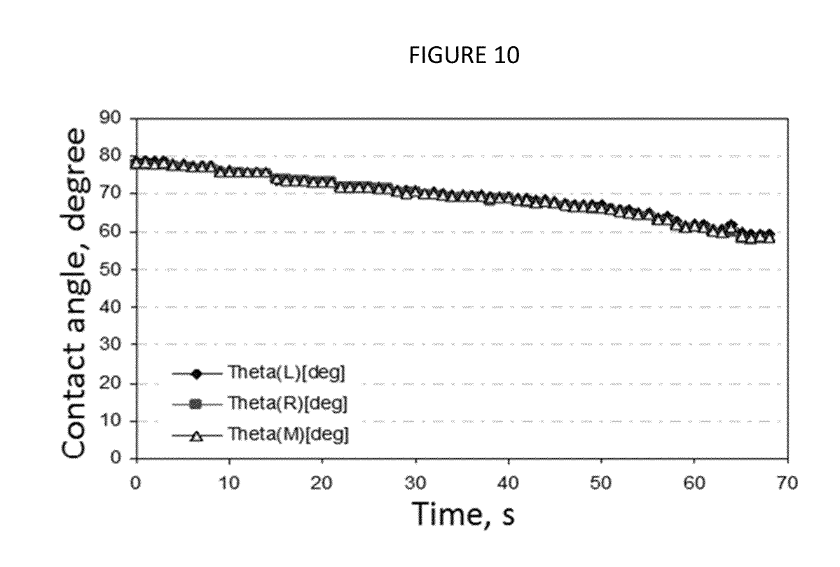

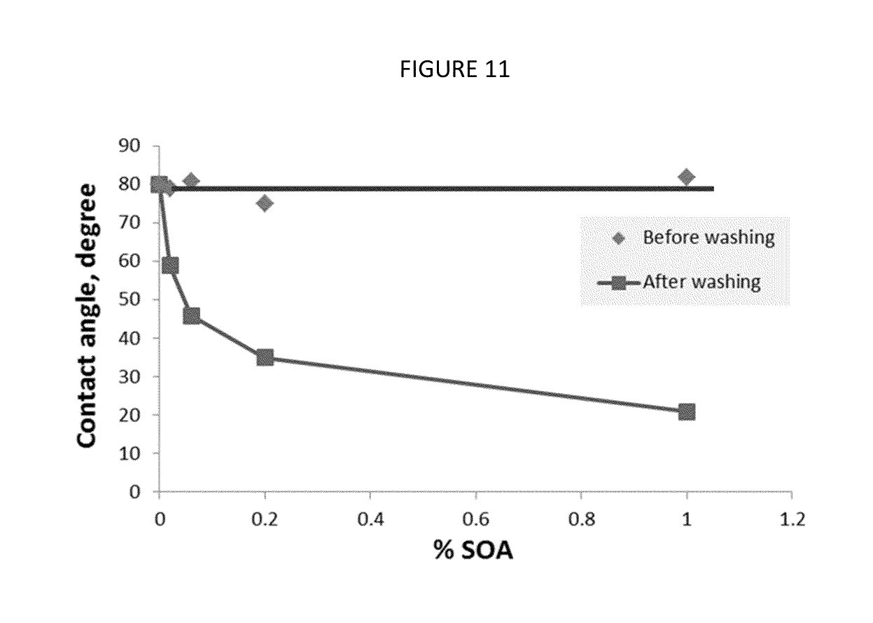

As shown in FIG. 10, coatings that include an amphiphilic polymer carrier and a balancing agent still exhibit surface reconstruction. It was observed that the inclusion of a balancing agent could affect some surface properties of the coating. For example, as shown in FIG. 11, the contact angle after washing decreased with the amount of balancing agent (i.e., SOA) added, indicating the surface of the coating becoming more hydrophilic. Without washing, however, the contact angle of the coating was the same with and without the balancing agent.

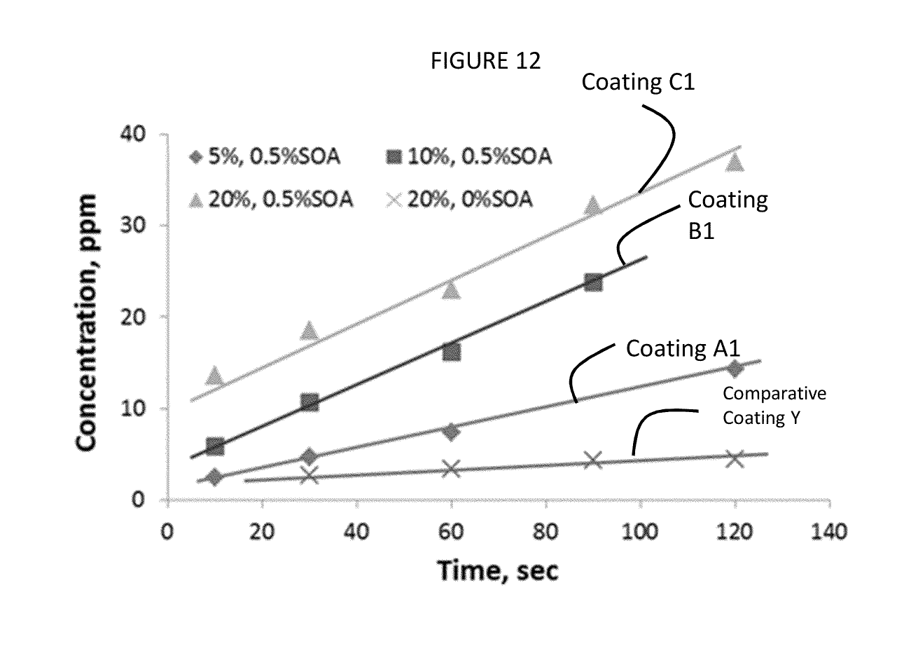

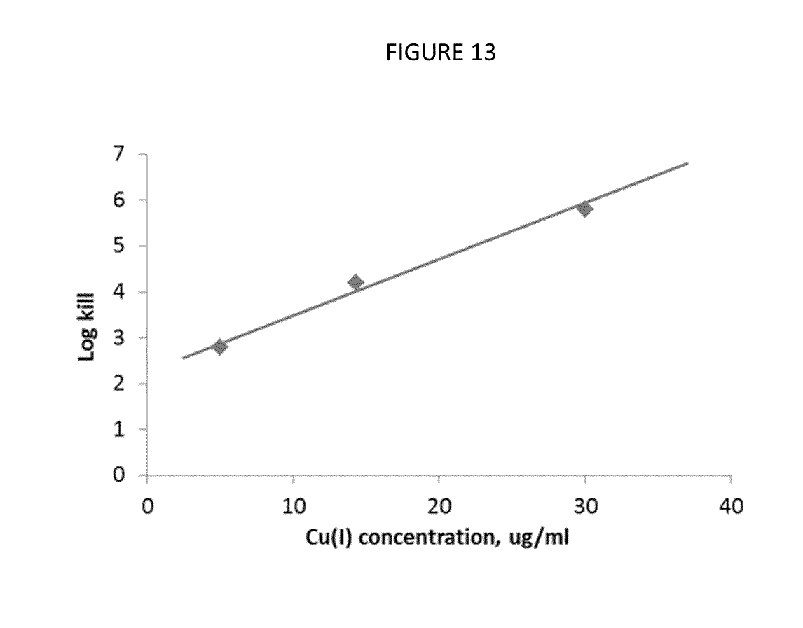

It was also observed that the amount of active copper species leached may be improved by the inclusion of a balancing agent (i.e., SOA), as shown in FIG. 12, which could explain why coatings that include a balancing agent exhibit high antimicrobial performance. FIG. 12 will be discussed in greater detail in the Examples. FIG. 13 shows the relationship of antimicrobial performance and the concentration of active copper species leaching out from the coating within two hours.

In one or more embodiments, the coating described herein may be applied to a surface to form a coated surface. The coated surface may exhibit at least 3 log reduction in the concentration of at least one of Staphylococcus aureus, Enterobacter aerogenes, Pseudomonas aeruginosa bacteria, Methicillin Resistant Staphylococcus aureus, and E. coli, under EPA Test Method for Efficacy of Copper Alloy as a Sanitizer testing conditions. In some embodiments, the coated surface may exhibit at least a 4 log, or even at least a 5 log reduction in the concentration of at least one of Staphylococcus aureus, Enterobacter aerogenes, Pseudomonas aeruginosa bacteria, Methicillin Resistant Staphylococcus aureus, and E. coli, under EPA Test Method for Efficacy of Copper Alloy as a Sanitizer testing conditions.

In one or more embodiments, the coated surface may be subjected to surface treatment (e.g., plasma treatment, sanding, etching etc.) to expose the copper particles in the coating. In some examples, about 10 mg of the surface is removed to expose the copper particles. In one or more embodiments, the surface treatment forms a treated surface, at which the coating exhibits enhanced antimicrobial performance.

In one or more embodiments, the coated surface may exhibit a stable color that does not undergo substantial changes after exposure to specific environments. For example, the coated surface may exhibit a delta (A) E of less than about 2 or even less than about 1, as measured by ASTM D2247, after being exposed to a temperature of 38° C. at 100% relative humidity for 7 days. As used herein, the phrase “delta (A) E” refers to the total color distance as measured by the distance between two color coordinates, provided under the CIELAB color space (ΔE_{ab}*−\sqrt{(L*₂−L*₁)²+(a*₂−a*₁)²+(b*₂−b*₁)²}).

The coated surface may also exhibit chemical resistance to various chemicals, as measured by ASTM D1308, after exposure to chemicals in the center of a test piece for 1 hour.

The coatings described herein may include pigments to impart color to the coatings. Accordingly, the coatings may exhibit a wide variety of colors, depending on the carrier color, mixture of carriers and amount of particle loading. Moreover, the coatings described herein showed no adverse effect to paint adhesion as measured by ASTM D4541. In some instances, the adhesion of the coating to an underlying substrate was greater than the cohesive strength of the substrate. In other words, in testing, the adhesion between the coating and the substrate was so strong that the underlying substrate failed before the coating was separated from the surface of the substrate. For example, where the substrate includes wood, the adhesion between the coating and the substrate may be about 300 psi or greater, 400 psi or greater, 500 psi or greater, 600 psi or greater and all ranges-sub-ranges therebetween, as measured by ASTM D4541. In some instances, the antimicrobial coating, when applied to a substrate, exhibits an anti-sag index value of about 3 or greater, about 5 or greater, 7 or greater, 8 or greater, 9 or greater, 10 or greater, 11 or greater, 12 or greater, 13 or greater, 14 or greater or even 15 or greater, as measured by ASTM D4400.

The antimicrobial coating may exhibit sufficient durability for use in household and commercial applications. Specifically, the antimicrobial coating, when applied to a substrate, exhibits a scrub resistance as measured by ASTM D4213 of about 4 or greater, 5 or greater, 6 or greater, 7 or greater and all ranges and sub-ranges therebetween.

Another aspect of the present disclosure pertains to a method for forming the antimicrobial coatings described herein. In one or more embodiments, the method includes synthesizing a plurality of copper particles having a stable copper state of Cu¹⁺ as described herein, and dispersing the particles in a carrier. In one or more embodiments, the method includes synthesizing the plurality of copper particles by forming a copper core and at least partially surrounding the copper core with a porous shell. The porous shell may include an inner surface in communication with the copper core and an outer surface. In one or more embodiments, the method may include rendering at least a portion of the plurality of copper particles hydrophobic. In one example, the method includes rendering the outer surface of such particles hydrophobic by combining the plurality of particles with a balancing agent, as described herein. In one or more specific embodiments, the step of rendering the outer surface of the particles hydrophobic may include providing the particles in an suspension with water, alcohol or a mixture thereof, mixing the balancing agent into the suspension and then removing the alcohol (if any) from the mixture.

The resulting coating may be applied onto a substrate through known coating processes (e.g., dip coating, spray coating, slot coating and the like). The coating may then be dried and/or cured to achieve a coated surface that exhibits antimicrobial activity, as described herein.

One example of a synthesis process that can be utilized in one or more embodiments is described in PCT Patent Application No. PCT/US2012/054126, entitled “Antimicrobial Composite Material”, the content of which is incorporated herein in its entirety. In one or more embodiments, the step of synthesizing the particles includes providing an amount of 0.25M Cu₂SO₄ (e.g., 80 mL), adding an amount of 0.005M of SOA (e.g., 40 mL) to the Cu₂SO₄ to provide a mixture, and stirring the mixture at a specific temperature (e.g., 80° C.) to form a dispersion. The method may include precipitating Cu²⁺ by, for example, adding an amount of 1M NaOH (e.g., 40 mL) to the dispersion. The NaOH may be added to the dispersion at a temperature of about 80° C., while stirring. The method of one or more embodiments may include reducing, in situ, the precipitate by adding an amount of 2.5% hydrazine hydrate (e.g., 20 mL) to the precipitate while stirring. The method may also include adding about 10 mL of 0.25M Na₂SiO₃ at 80° C. while stirring and then adding 1M HCl until a pH in the range from about 8.5 to about 11 is reached, while stirring at 80° C., for approximately 3 hours. In some alternative embodiments, 1M NaOH may be used to adjust the pH.

In one or more embodiments, the resulting copper particles are then filtered and washed with H₂O and dried. The washed particles are then treated with 0.25M H₂SO₄ for 24 hrs to form Cu₂O—SiO₂ core-shell particles with Cu²⁺ removed. The particles with Cu²⁺ removed are separated into Cu₂O—SiO₂ core-shell particles with Cu⁰. In one or more variants, the method may be modified to include reducing the Cu¹⁺ to Cu⁰ in a H₂/N₂ atmosphere, changing pH of the reaction system, changing concentration of the reactants in the reaction system, or changing sequence of adding the chemicals, or other changes. The particles may be mixed with water, alcohol or a combination thereof to provide a suspension for later combination with the balancing agent and/or carrier.

In one or more alternative embodiments, the method may omit the step of washing the particles. In such embodiments, the copper particles include a residual coating of SOA, and thus include a balancing agent, without having to add the balancing agent to the particulate suspension. In this manner, such copper particles in suspension may be prepared for combination with a carrier by simply removing the alcohol (if any) and combining the copper particles (with the balancing agent already in communication with the outer surface of the copper particles) with the carrier.

### EXAMPLES

Various embodiments will be further clarified by the following examples.

### Example 1

Copper particles according to the embodiments described herein were prepared by mixing and stirring about 80 ml of 0.005M sodium oleate (SOA), 160 ml of 0.25M CuSO₄ and 80 ml water in 1 L reactor in a water bath having a temperature of about 80° C. until a clear solution was formed. About 80 ml of 1M NaOH was added this mixture and the reaction solution was adjusted to a pH of about 8 or 9. To the reaction solution, 40 ml of 2.5% hydrazine hydrate was added to reduce the Cu(OH)₂ such that light brick-red Cu₂O, dark brick red Cu⁰ or a mixture of Cu¹⁺/Cu⁰ particles precipitate, depending on the pH of the reaction solution. Thereafter, a 0.25M Na₂SiO₃ solution was dropped into the suspension to provide the porous shell around the copper core, and 1M HCl was used to adjust the pH. The resulting suspension was centrifuged and the resulting particles were washed and re-centrifuged with alcohol and stored in alcohol.

A first coating including no copper particles and only a commercially available carrier described as a clear gloss protective finish, available under the trademark Polycrylic® from Minwax Company was prepared (Comparative Coating A). A second coating identical to Comparative Coating A, but with about 1.0 wt % SOA was prepared (Comparative Coating B). A third coating having 10% copper particle loading with no SOA was prepared (Coating C). A fourth coating having 10% copper particle loading and 0.5 wt % SOA was prepared (Coating D).

Coating D was prepared using a 15 wt % Cu₂O/SiO₂ core/shell copper particle suspension formed as described above. About 0.25 g of 2% SOA water/alcohol (70:30, wt/wt) solution was added to about 0.67 g of the copper particle/alcohol suspension. The mixture was mixed well and alcohol was removed by N₂ blowing, and the about 2.56 g of Polycrylic® (having about 35% solids) was added. The coating included a total amount of 0.5 wt % SOA. Coating C was prepared in an identical manner, but without the addition of SOA.

Comparative Coatings A and B and Coatings C and D were each applied to identical substrate to determine antimicrobial performance. To determine such performance, antibacterial tests were carried out using the EPA-approved Test Method for Efficacy of Copper Alloy Surfaces as a Sanitizer (“EPA Test”), which is incorporated herein by reference in its entirety. In the examples described herein, Staphylococcus aureus (ATCC 6538) was cultured for 5 consecutive days before the testing was performed. Bacterial culture was mixed with serum (5% final concentration) and Triton X-100 (final concentration 0.01%). Each sample/carrier was inoculated with 20 ul of the bacterial suspension and allowed to dry (typically, for about 20 minutes to 40 minutes) at room temperature and 42% relative humidity prior to being exposed to bacterial for a 2 hour exposure period. After 2 hours of exposure, bacteria are washed from the carrier using neutralizer buffer and plated onto Tryptic soy agar plates. Twenty-four hours after incubation at 37° C., bacteria colony formation was examined and counted. Geometric mean and percent reduction were calculated based on the colony number from samples relative to glass carrier or appropriate paint control. The benchmark of 3 log reduction was used to compare antimicrobial activity of different coatings.

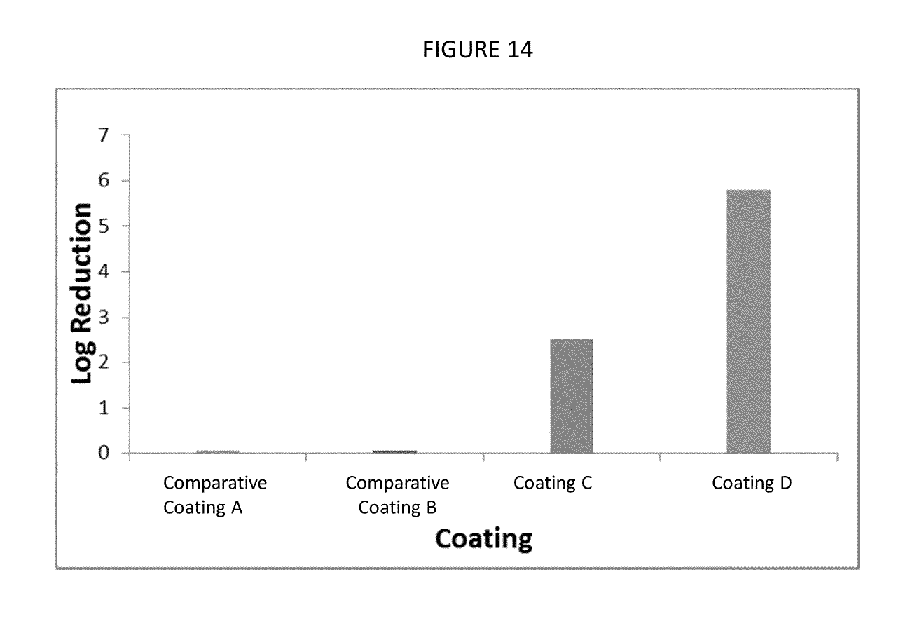

FIG. 14 shows a comparison of the antimicrobial performance of Comparative Coatings A-B and Coatings C-D, under the EPA Test with respect to Staphylococcus aureus. As shown in FIG. 14, Comparative Coatings A and B, which included only the carrier or the carrier and balancing agent, but no particles, exhibited no significant antimicrobial activity. Coating C, which included the carrier and particles, but no balancing agent, exhibited some antimicrobial activity (i.e., about 2 to 2.5 log reduction); the antimicrobial activity of Coating C can be (at least partially) attributed to the amphiphilic property of Polycrylic® carrier used. Coating D exhibited significantly higher antimicrobial performance (i.e., greater than about 5 log reduction)—demonstrating the benefits of a balancing agent in coatings for antimicrobial performance.

### Example 2

Coating samples (Coatings E-J) using different amounts of copper particles were prepared. The copper particles were the same as those used in Example 2 but were sourced from different batches. The copper particles were combined with SOA to provide a total amount of SOA in the coating samples of about 0.5 wt %.

Comparative Substrate 1 included a metallic copper substrate, with no coating. Coatings E-J included a Polycrylic® carrier and copper particles formed as described above in Example 1. The relative amounts of copper particles are provided in Table 1.

TABLE 1
Coatings E-J, based on total weight of the coating.

| | Cu₂O/SiO₂ core/shell | |
|---|---|---|
| | Particle loading | |
| Coating | wt %/wt % | SOA |
| Coating E | 20% | 0.5 wt % |
| Coating F | 10% | 0.5 wt % |
| Coating G | 5% | 0.5 wt % |
| Coating H | 20% | 0.5 wt % |
| Coating I | 10% | 0.5 wt % |
| Coating J | 5% | 0.5 wt % |

To form Coatings E and H, with 20% copper particle loading, 1.33 g of a 15 wt % Cu20/SiO₂ suspension is combined with about 0.25 g of 2% SOA water/alcohol (70:30, wt/wt) solution. The mixture was mixed well and alcohol was removed by N₂ blowing, and the about 2.27 g of Polycrylic® (having about 35% solids) was added. Coatings F and I were formed in the same manner as Coatings E and H; however, 0.67 g of the 15 wt % Cu₂O/SiO₂ suspension was combined with about 0.25 g of 2% SOA water/alcohol (70:30, wt/wt) solution. After removal of alcohol from the particle-SOA mixture, about 2.56 g of Polycrylic® (having about 35% solids) was added to form Coatings F and I. Coatings G and J were formed in the same manner as Coatings E and H; however, 0.33 g of the 15 wt % Cu₂O/SiO₂ suspension was combined with about 0.25 g of 2% SOA water/alcohol (70:30, wt/wt) solution. After removal of alcohol from the particle-SOA mixture, about 2.7 g of Polycrylic® (having about 35% solids) was added to form Coatings G and J.

Coatings E, F, G, H, I and J were each coated onto identical substrates and tested, along with Comparative Substrate 1, using the same EPA Test as Example 1, with respect to Staphylococcus aureus.

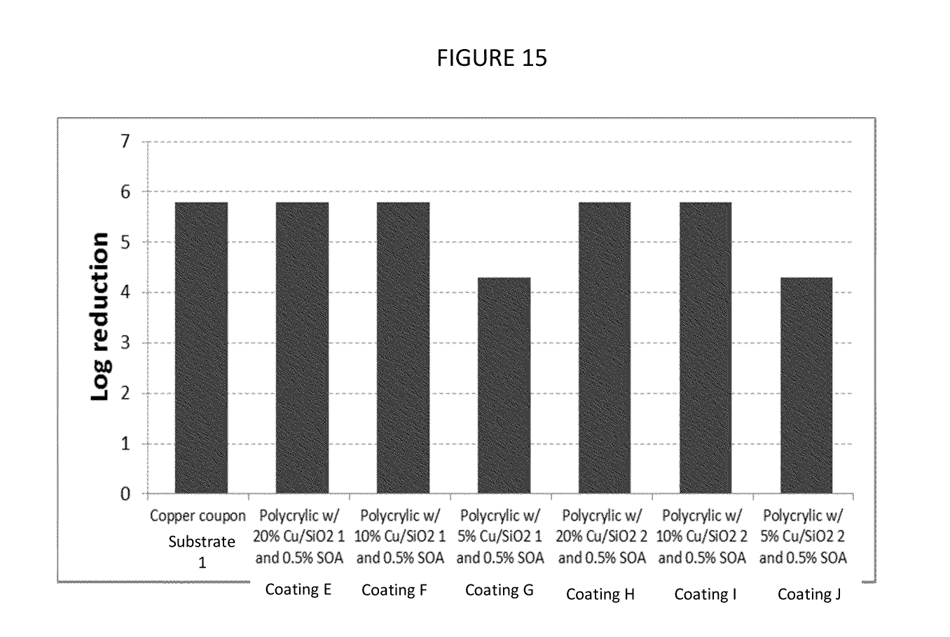

FIG. 15 compares the antimicrobial performance of Comparative Substrate 1 and Coatings E, F, G, H, I and J. As shown in FIG. 15, the coatings that included 0.5 wt % SOA and a particle loading of about 10% or greater exhibited about the same antimicrobial performance (i.e., close to a 6 log reduction) as the pure copper coupon of Substrate 1. At only a 5% particle loading, Coatings G and J exhibited greater than about a 4 log reduction.

### Example 3

Coating samples (Coatings K-P) using different amounts of balancing agent were prepared. Coatings L-P included the same copper particles that were used in Example 1. The copper particles were combined with different amounts of SOA to provide a total particle loading of about 10%. Coating K included the same copper particles, particle loading (i.e., 10%) and carrier (Polycrylic®) as Coatings L, M, N, O and P, but included no SOA. Coatings L-O included relative amounts of SOA, as provided in Table 2.

TABLE 2
Coatings K-P, based on total weight of the coating.

| | Cu₂O/SiO₂ core/shell | |
|---|---|---|
| | Particle loading | |
| Coating | (wt %/wt %) | SOA |
| Coating K | 10% | 0 wt % |
| Coating L | 10% | 0.1 wt % |
| Coating M | 10% | 0.3 wt % |
| Coating N | 10% | 0.5 wt % |
| Coating O | 10% | 0.75 wt % |
| Coating P | 10% | 1 wt % |

To form Coatings L-P, about 0.67 g of a 15 wt % Cu₂O/SiO₂ suspension was combined with different amounts of 2% SOA water/alcohol (70:30, wt/wt) solution. The mixture was mixed well and alcohol was removed by N₂ blowing, and the about 2.56 g of Polycrylic® (having about 35% solids) was added.

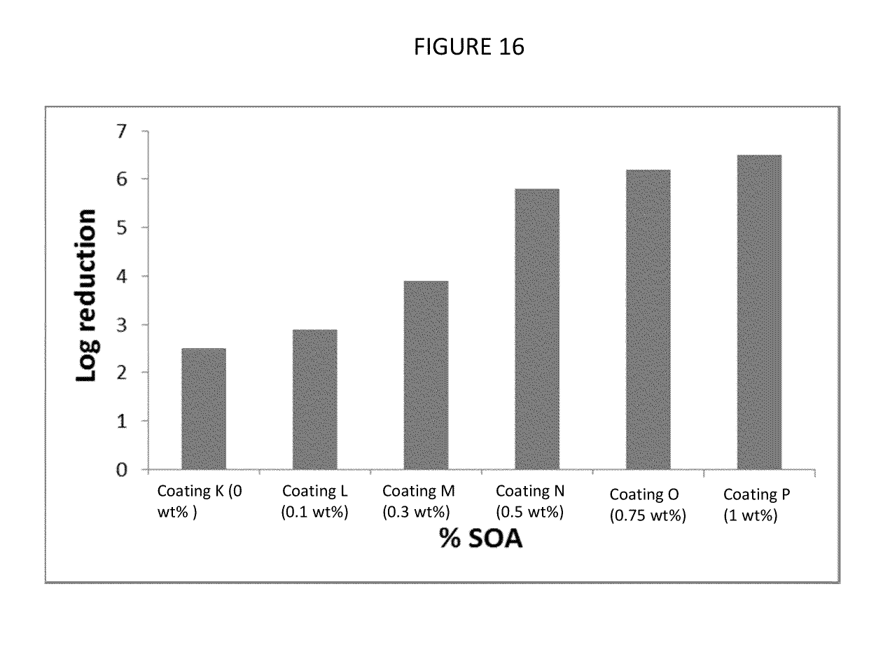

Coatings K-P were each applied to identical substrates and tested using the same EPA Test as Example 1, with respect to Staphylococcus aureus. FIG. 16 shows the correlation of antimicrobial performance with the relative amounts of SOA added to the coatings. Antimicrobial performance improved with the presence of at least about 0.1 wt % SOA in the coating and continued to increase when 0.5 wt % SOA was included in the coating.

### Example 4

Coatings Q and R were prepared using different carriers from those used in Examples 1-3. The copper particles utilized in Coatings Q and R were identical to those used in Example 1 and were incorporated into commercially available carriers available from BEHR: Behr® white semi-gloss and Behr® white satin to provide Coatings Q and R. Coatings Q and R both included a 15% copper particle loading and 1.0 wt % SOA. To prepare Coatings Q and R, about 1 g of the 15 wt % Cu₂O/SiO₂ suspension was combined with about 0.5 g of 2% SOA water/alcohol (70:30, wt/wt) solution. The mixture was mixed well and alcohol was removed by N₂ blowing, and the about 1.69 g of Behr® white semi-gloss (Coating Q) and Behr® white satin (Coating R) (both having about 50% solids) was added.

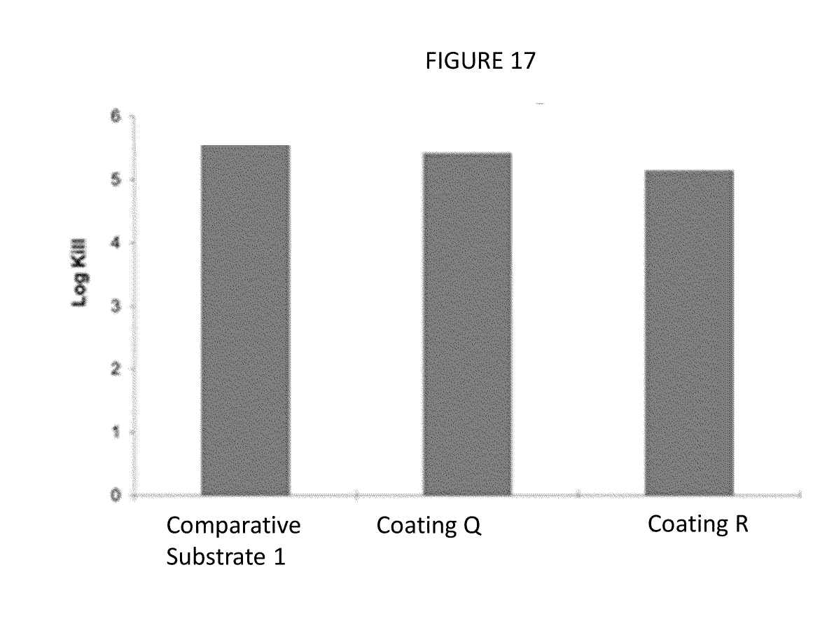

Coating Q and R were each applied to identical substrates and tested using the same EPA Test as Example 1, with respect to Staphylococcus aureus. For comparison, Comparative Substrate 1 was also tested. FIG. 17 shows that antimicrobial performance was also observed when the carrier changed from Examples 1-3 to the carrier used in FIG. 17.

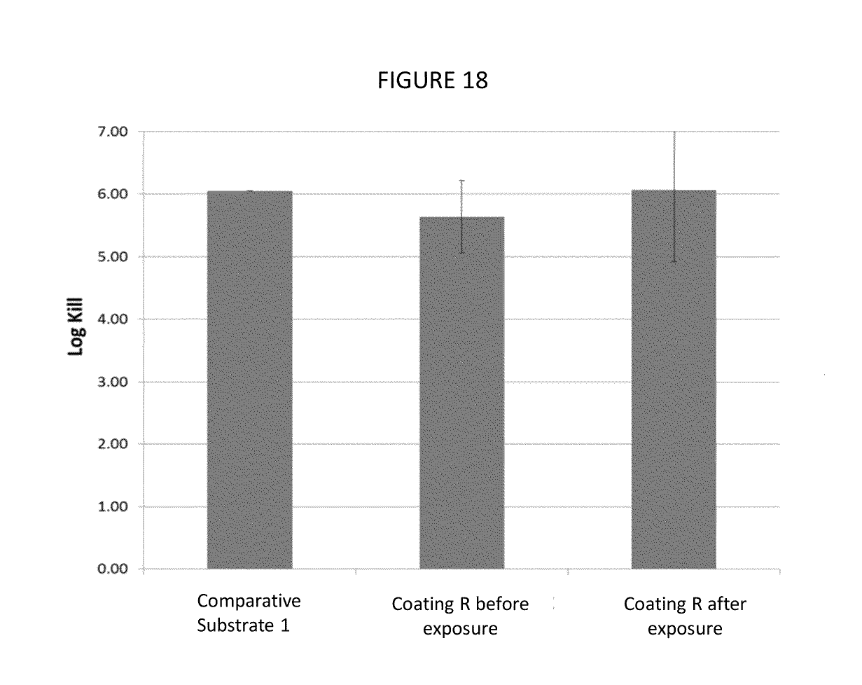

The performance of Coating R before and after aging was also evaluated and compared to Comparative Substrate 1 (metallic copper substrate). Coating R was coated onto a substrate and immediately tested for antimicrobial activity using the same EPA Test as Example 1. Coating R was also coated onto an identical substrate and then aged by exposing to air having a temperature of about 38° C. and relative humidity for 24 hours. FIG. 18 shows there is substantially no difference in the performance of Coating R before aging and after aging and no difference in performance as compared to Comparative Substrate 1.

### Example 5

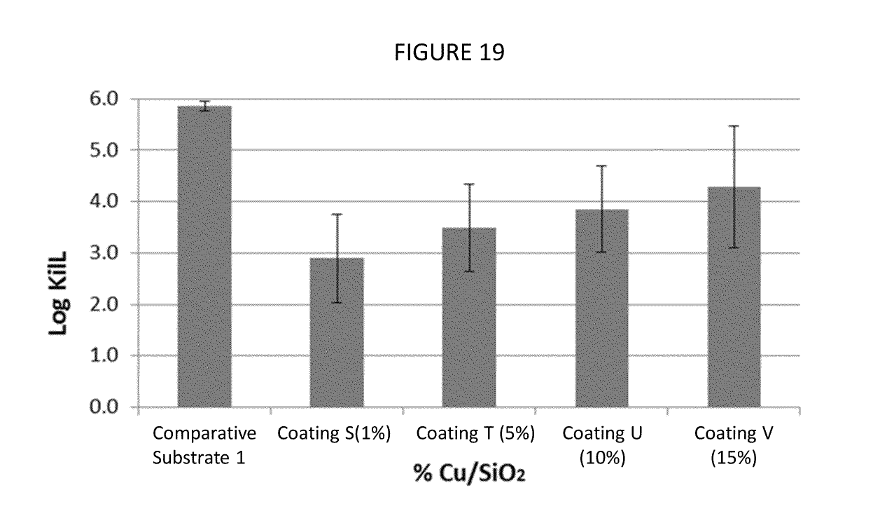

Coating samples (Coatings S, T, U and V) having the same carrier as each bother but different particle loadings were prepared. The copper particles used were identical to those used in Example 1 and the same amount of SOA was utilized in each of Coatings S-V. Coatings S, T, U and V were each applied to identical substrates and tested using the same EPA Test as Example 1, with respect to Staphylococcus aureus. For comparison, Comparative Substrate 1 was also tested under the same EPA Test. FIG. 19 shows the antimicrobial performance of Comparative Substrate 1 and Coatings S, T, U and V. FIG. 19 illustrates that even a 5% loading of particles is sufficient to achieve a 3 log reduction in Staphylococcus aureus, under the EPA Test.

### Example 6

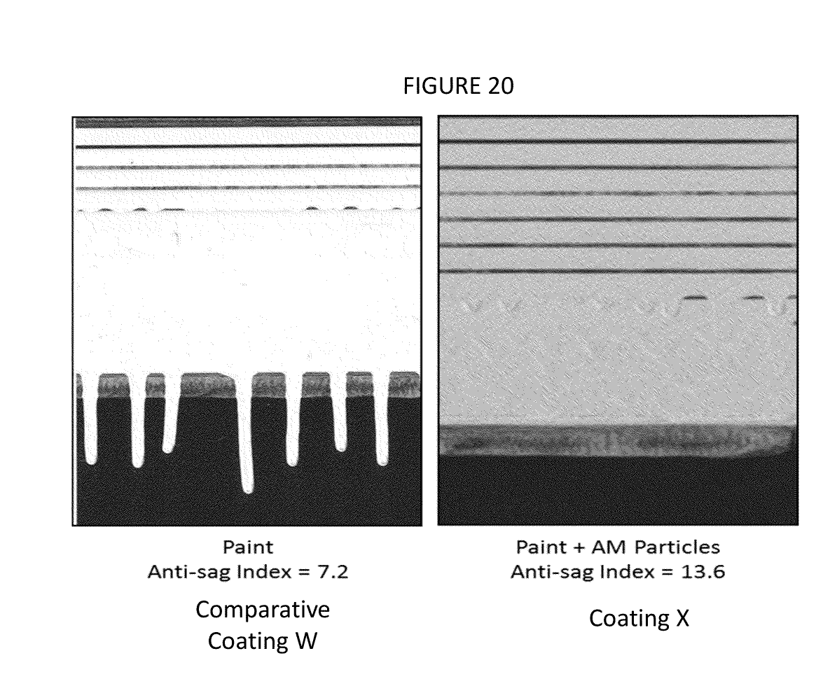

Comparative Coating W and Coating X were prepared having the same carrier. Comparative Coating W included only a commercially available paint carrier and no copper particles or SOA. Coating X included the same carrier as Comparative Coating W and 15% particle loading, using the same particles as Example 1, and 0.05 wt % SOA. Comparative Coating W and Coating X were each coated onto identical substrates and evaluated under ASTM D4400 for sag resistance. As shown in FIG. 20, Coating X exhibited an anti-sag index of 13.6, while Comparative Coating W exhibited an anti-sag index of 7.2.

### Example 7

Comparative Coating Y and Coatings A1, B1 and C1 were prepared using different carriers. Comparative Coating Y used a carrier of Behr® white high gloss paint and Coatings A1, B1 and C1 used a carrier Behr® white semi-gloss. Comparative Coating Y included 20% copper particle loading with no balancing agent. Coatings A1, B1 and C1 included 0.5 wt % SOA and 5%, 10% and 20% particle loadings, respectively. To form Coating A1, with 20% copper particle loading, 1.33 g of a 15 wt % Cu₂O/SiO₂ suspension is combined with about 0.25 g of 2% SOA water/alcohol (70:30, wt/wt) solution. The mixture was mixed well and alcohol was removed by N₂ blowing, and the carrier was added to provide 5% particle loading. Coating B1 was formed in the same manner as Coating A1; however, 0.67 g of the 15 wt % Cu₂O/SiO₂ suspension was combined with about 0.25 g of 2% SOA water/alcohol (70:30, wt/wt) solution. After removal of alcohol from the particle-SOA mixture, the carrier was added to form Coating B1 with a 10% particle loading. Coating C1 was formed in the same manner as Coating A1; however, 0.33 g of the 15 wt % Cu₂O/SiO₂ suspension was combined with about 0.25 g of 2% SOA water/alcohol (70:30, wt/wt) solution. After removal of alcohol from the particle-SOA mixture, the carrier was added to form Coating C1, with a 20% particle loading.

Comparative Coating Y and Coatings A1, B1 and C1 were tested to determine the leach rate, based on the procedures set forth in Standard Method 3500 Copper https://www.nemi.gov/methods/method_summary/7425/. The procedure utilized reagents prepared as follows:
a. Stock copper solution (5 μg/mL Cu²⁺ solution): Add 0.529 g CuCl₂ into 50 mL volumetric flask and fill the flask to 50 mL with DI water (5 mg/mL Cu²⁺; then make a 1:1000 dilution by adding 0.1 mL of above 5 mg/mL Cu²⁺ solution into a 100 ml volumetric flash and fill the flask to 100 mL (5 μg/mL Cu²⁺ solution).
b. Hydroxylamine-hydrochloride solution (10% m/v NH₂OH.HCl): add 5 g NH₂OH.HCl into 50 mL DI water.
c. Neocuproine solution (0.2% m/v neocuproine): Dissolve 100 mg of 2,9-dimethyl-1,10-phenanthroline in 50 ml methanol.
d. Buffer solution (pH˜6): Add 14.4 g potassium acetate and 0.089 mL acetic acid into 100 ml volumetric flask and then dilute to 100 ml solution with DI water.

The calibration curve was determined by adding 0.00 mL, 0.50 mL,1.00 mL, 2.00 mL, 3.00 mL, and 5.00 mL stock—5 μg/mL copper solutions into six separate 25 ml volumetric flasks, adding 15 mL DI water, 1.5 mL 10% m/v NH₂OH.HCl solution, 3 mL buffer solution, 1.5 ml neocuproine solution to the flask and then filling with DI water to the 25 mL line. After 5 min, absorbance at 457 nm was measured and each data point has three repeats.

Leachates from the Comparative Coating Y and Coatings A1, B1, and C1 were collected at different time intervals to determine leach rate, using the following procedure. The Comparative Coating Y and Coatings A1, B1 and C1 were each applied to identical substrates having dimensions of 1 inch x 1 inch and dried/cured identically to provide coated surfaces. The coated surfaces were then cleaned by spraying 70% ethanol and rubbed dry with a Kim wipe. The coated surfaces were then adhered with doubled sided tape to a petri dish. 20 μL of consumed broth was pipetted onto each coated surface and spread with the pipette tip. The broth was allowed to set for different time intervals up to 2 hours on each coated surface. To determine the leach rate, the broth was allowed to set on different coated surface samples for 10 minutes, 30 minutes, 60 minutes, 90 minutes and 120 minutes. After each such time interval 1 mL of water was pipetted into the petri dish. The respective coated surface was scraped with mini cell scrapers as follows: first around the outside and then on diagonals from top to bottom, turn and scrap other diagonal from top to bottom using a new scraper for each sample. Each substrate was rinsed with the liquid in the petri dish using a fresh pipette tip five times. About 0.8 mL of liquid was extracted from the petri dish to provide recovered leachate. The recovered leachate was added to cell tubes, to which 0.7 mL 10% m/v NH₂OH.HCl in water solution, 1 mL potassium acetate/acetic acid buffer solution and 0.8 mL 0.2%(m/v) neocuproine in methanol solution was added. A blank was made by adding 20 μL of consumed broth, 0.7 mL 10% m/v NH₂OH.HCl in water solution, 1 ml pH5.7 potassium acetate/acetic acid buffer solution and 0.8 mL 0.2% (m/v) neocuproine in methanol solution. UV-VIS bulbs were allowed to warm up for 15 minutes. The leachate and blank were measured with UV-VIS at 457 nm.

FIG. 12 illustrates the leaching rate for Comparative Coating Y and Coatings A1, B1 and C1. As shown in FIG. 12, the presence of SOA increased the leaching rate, as did the increase particle loading in the coating.

It will be apparent to those skilled in the art that various modifications and variations can be made without departing from the spirit or scope of the invention

What is claimed is:

1. An antimicrobial coating comprising:
a carrier; and
a plurality of copper particles dispersed in the carrier, the plurality of particles comprising a stable copper state of Cu¹⁺.

2. The antimicrobial coating of claim 1, wherein the stable copper state further comprises at least one of Cu⁰ and Cu²⁺.

3. The antimicrobial coating of claim 1, wherein the stable copper state is maintained after exposure to a reducing environment or an oxidizing environment.

4. The antimicrobial coating of claim 1, wherein the plurality of copper particles each comprise a copper core and a porous shell at least partially surrounding the copper core, the porous shell comprising an inner surface in communication with the copper core and a hydrophobic outer surface.

5. The antimicrobial coating of claim 4, further comprising a balancing agent in communication with at least a portion of the hydrophobic outer surface, wherein the balancing agent comprises a hydrophilic head and a hydrophobic tail.

6. The antimicrobial coating of claim 5, wherein the balancing material comprises at least one of an anionic surfactant, a carboxylic acid-based surfactant, a hydrophilic polymer, and a water-soluble polymer.

7. The antimicrobial coating of claim 5, wherein the hydrophilic head is in communication with the porous shell.

8. The antimicrobial coating of claim 5, comprising about 0.1 wt % to about 2 wt % of the balancing agent.

9. The antimicrobial coating of claim 5, further comprising about 1 wt % to about 20 wt % of the plurality of copper particles.

10. The antimicrobial coating of claim 4, wherein the porous shell comprises silica.

11. The antimicrobial coating of claim 10, wherein the porous shell comprises a thickness in the range from about 0.01 to about 100 nm.

12. The antimicrobial coating of claim 4, wherein plurality of particles comprises a molar ratio of the copper core to the porous shell of about 1:1 or greater.

13. The antimicrobial coating of claim 12, wherein the molar ratio is in the range from about 1:1 to about 10:1.

14. The antimicrobial coating of claim 1, wherein the plurality of copper particles have an average diameter in the range of from about 100 nm to about 10 microns.

15. The antimicrobial coating of claim 14, wherein the copper core comprises less than about 20 wt % of Cu2+.

16. The antimicrobial coating of claim 1, wherein the carrier comprises either one or more of a polymer, and a pigment.

17. The antimicrobial coating of claim 1, wherein, when applied to a surface of a substrate, the antimicrobial coating exhibits a 3 log reduction or greater in the concentration of at least one of Staphylococcus aureus, Enterobacter aerogenes, Pseudomonas aeruginosa bacteria, Methicillin Resistant Staphylococcus aureus, and E. coli, under EPA Test Method for Efficacy of Copper Alloy as a Sanitizer testing conditions.

18. The antimicrobial coating of claim 1, wherein, when applied to a surface of a substrate, the antimicrobial coating exhibits either one or both:
a delta E of less than about 2, as measured by ASTM D2247, after being exposed to a temperature of 38° C. at 100% relative humidity for 7 days, and
an adhesion of about 400 psi or greater, as measured by ASTM D4541.

19. A method of forming an antimicrobial coating comprising:
synthesizing a plurality of copper particles having a stable copper state of Cu1+ by forming a copper core and at least partially surrounding the copper core with a porous shell comprising an inner surface in communication with the copper core and an outer surface,
rendering at least a portion of the plurality of copper particles hydrophobic; and
dispersing the plurality of copper particles in a carrier.

20. The method of claim 19, wherein rendering the outer surface hydrophobic comprises combining the plurality of particles with a balancing agent comprising a hydrophilic head and a hydrophobic tail.
